(19) United States
(12) Patent Application Publication
(10) Pub. No.: US 2024/0274033 A1
(43) Pub. Date: Aug. 15, 2024

(54) SIGN LANGAUGE AND GESTURE CAPTURE AND DETECTION

(71) Applicant: Microsoft Technology Licensing, LLC, Redmond, WA (US)

(72) Inventor: Saurabh BANSAL, Dehradun (IN)

(21) Appl. No.: 18/565,261

(22) PCT Filed: May 24, 2022
(86) PCT No.: PCT/US2022/030612

§ 371 Date: Nov. 29, 2023

(30) Foreign Application Priority Data
Jun. 24, 2021 (IN) 202111028446

(51) Int. Cl. G09B 21/00; G06F 3/01; G06V 10/25; G06V 10/30; G06V 20/40; G06V 40/20; H04L 12/18

(52) U.S. Cl. CPC G09B 21/009; G06F 3/017; G06V 10/25; G06V 10/30; G06V 20/49; G06V 40/28; H04L 12/1831

(57) ABSTRACT

Systems and methods may be used for sign language and gesture identification and capture. A method may include capturing a series of images of a user and determining whether there are regions of interest in an image of the series of images. In response to determining that there is a region of interest in a particular image of the series of images, the method may include determining whether the region of interest includes a gesture movement by the user and determining whether the region of interest includes a sign language sign movement by the user. An image representation of a gesture or a sign may be generated.

### BACKGROUND

Many sign languages exist worldwide, with some estimates indicating that over 200 may be in use today. Sign languages provide one technique for those with hearing or speaking difficulties to communicate. Sign languages are often national, and thus, more than one sign language may correspond to a written or spoken language. For example, although spoken English is shared by America and Britain with mostly minor differences, American Sign Language and British Sign Language differ significantly in certain aspects. Similarly, more than one spoken language may overlap geographically with a single sign language. Also, in many cases, a sign language differs in syntax, grammar, and expression from a geographically related spoken language.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example system diagram for providing sign language and gesture identification and capture according to some examples of the present disclosure.

FIG. 2 illustrates a flowchart for sign language or gesture detection according to some examples of the present disclosure.

FIG. 3 illustrates an example region of interest including a sign according to some examples of the present disclosure.

FIG. 4 illustrates an example captured a gesture according to some examples of the present disclosure.

FIG. 5 illustrates an example virtual whiteboard user interface on a display according to some examples of the present disclosure.

FIG. 6 illustrates a flowchart of a technique for sign language and gesture identification and capture according to some examples of the present disclosure.

FIG. 7 illustrates a block diagram of an example machine which may implement one or more of the techniques discussed herein according to some examples of the present disclosure.

### DETAILED DESCRIPTION

Systems and methods for sign language and gesture identification and capture are described herein. In an example, these systems and methods may be used to recognize a gesture or sign by a user, such as in an online collaboration session. A sign includes a specific hand, arm, or other body part movement or pose that is recognized as belonging to a sign language (e.g., as described above). A gesture is a movement of a hand, arm, or other body part to indicate a shape, text (e.g., a movement of a finger that traces a letter), image, or the like. A gesture may include movement that traces a path.

The systems and methods described herein improve interactions between people when at least one of the people has a speech impairment. The systems and methods described herein are rooted to a technological solution to achieve the improved interactions and deliver an end-to-end solution usable in settings such as business, education, manufacturing, administration, technology, or the like.

Specifically, technical advantages of the systems and methods described herein include enabling seamless capture, interpretation, and presentation of sign language or gestures by a user in a shared online or local space. The systems and methods described herein feature another advantage of integration with existing systems. The systems and methods described herein are directed to a technical solution of capturing, interpreting, and presenting information related to sign language and gestures. While some humans may understand sign language, many do not, and interpretation of sign language, for example during an online meeting is an important and difficult technical problem facing many organizations today. Further, a gesture may be made by a user that is difficult to interpret by eye alone, without visual representation using the systems and methods described herein. Still further, technological solutions described herein provide interpretation of both sign language and gestures. Sign language and gestures may be confused for one another and indecipherable to users.

The technical solutions described herein may reduce processing resources needed, by combining gesture detection and sign language detection in a single service, application, or system. For example, the technical solutions described herein may reduce machine resources needed to process mode-switches (e.g., from sign language mode to free drawing gesture mode). The technical solutions described herein may reduce bandwidth needed for an online video conference (e.g., by reducing repetition, reducing need for complex visual rendering, reducing need for switching between screen share and video feed, etc.).

Various uses of the systems and methods described herein may include educational settings, corporate settings, or the like. For example, in an educational setting, a teacher or student who has hearing or speech loss may communicate a thought, explanation, or question with the use of sign language and gesture drawings and text using the systems and methods described herein. In a business setting, the systems and methods described herein may be used with an online video conference system, which may include a virtual whiteboard or other editable document. Consider a scenario in which a presenter is explaining a business metric to an audience, the presenter does not need to walk up to a physical whiteboard and use a marker or scribble thoughts on the physical whiteboard. Instead, the presenter may stand as is and use a gesture (e.g., by moving a finger, hand, arm, etc.) for the explanation. The gesture may be recognized as a gesture by a system. The system may generate a visual representation of the gesture, such as for display on the virtual whiteboard.

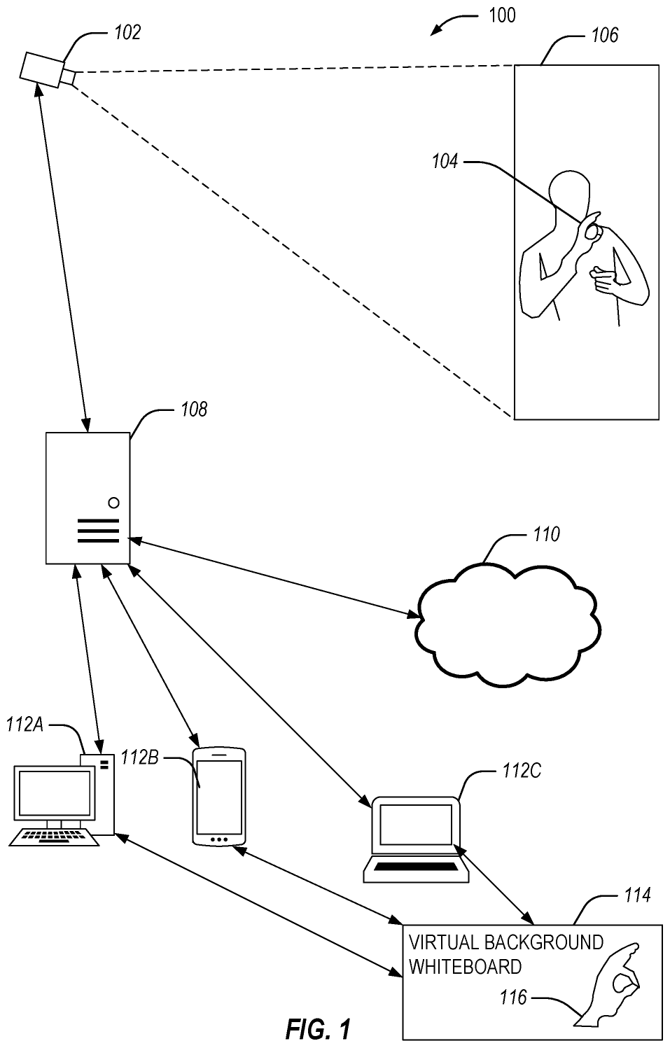

FIG. 1 illustrates an example system diagram 100 for providing sign language and gesture identification and capture according to some examples of the present disclosure. The diagram 100 illustrates a variety of devices of the example system, such as a camera 102, a computing device 108 (which may include the camera 102 as an integrated component or be connectively coupled to the camera 102), as well as a variety of optional user devices, such as user computing devices 112A (represented by a desktop computer), 112B (represented by a mobile device, such as a phone or a tablet), and 112C (represented by a laptop). The diagram 100 also includes a cloud or server (e.g., remote device) 110 representation.

In an example, the camera 102 captures a field of view 106, including a region of interest 104. The region of interest 104 may be processed (as described further below) to generate an image representation 116, which may be displayed on one or more of the user devices 112A-C in a user interface 114 (e.g., on a virtual whiteboard, in a text or image portion of an online video conference, via email or text message, etc.). In some examples, processing may be done on the local device 108 that is connected to or incorporates the camera 102. In other examples, processing may be done in the cloud 110 (and sent to the user devise 112A-C, although those connections are not shown for clarity). In some examples, processing may be done on one or more of the user devices 112A-C. In still other examples, a combination of two or more of these may be used (e.g., some processing on the computing device 108, the cloud 110, or a user device 112A-C).

The camera 102 may be used to generate a series of images (e.g., a video or feed) captured of the field of view 106. When the field of view 106 includes a the region of interest 104 (e.g., a hand, arm, etc.), an image or set of images of the series of images may be evaluated for sign language or a gesture. The series of images may be pre-processed, in an example. The series of images may be evaluated, and various outputs may result, such as text or an image representation. The outputs may be sent to a facilitator system, such as a virtual whiteboard or an online video conferencing system for display or further processing (e.g., converting text to audio to output as the audio).

Textual information may be displayed at a whiteboard and converted into speech in real-time, in some examples. In an example, a sign may include a name that a presenter is trying to address, and a notification (e.g., within an online conference, via email or text, etc.) may be sent to a user corresponding to the name.

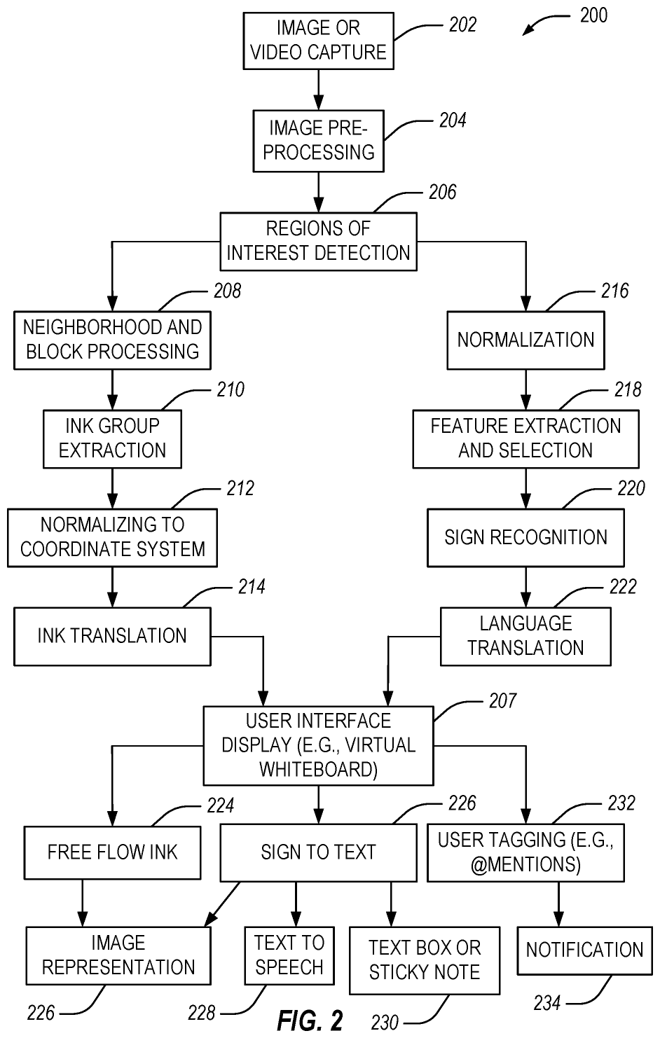

FIG. 2 illustrates a flowchart 200 for sign language or gesture detection according to some examples of the present disclosure. The flowchart 200 illustrates a technique for detecting a gesture or a sign (e.g., a movement or pose performed by a user indicating a sign of a sign language) and outputting information for display.

The technique may be implemented using a sign language recognition system to recognize signs, and a gesture recognition system to recognize gestures. The sign language recognition system may be used to manage image capturing, in an example. At operation 202, image or video may be captured, for example via a web cam, a camera of a phone or computer, a conferencing hub camera device in a meeting room, classroom, conference room, etc., or the like.

The captured image or video feed may undergo coarse preprocessing at operation 204. Image preprocessing may include determining or ensuring that the images are of sufficient quality (e.g.,

based on number of pixels, size, quality score, etc.) to be applied to a machine learning algorithm and do not have anything that is not needed in the image. Example image preprocessing may include, blue or focus correction, filtering or noise removal, edge enhancements, or the like. At operation 206, an image or series of images may be checked for a region of interest. To detect a region of interest, a subregion of an image may be determined to include a particular set of characteristics. The region of interest may be detected using a machine learning algorithm, an image classifier, or the like. In some examples, more than one region of interest may be present in an image or series of images. After a region of interest is detected (assuming no other regions of interest are present in an image), the pixels outside the region of interest may be discarded (e.g., set to 0). Subregions may be classified into various shapes defined in mathematics, such as freehand, circle, ellipse, line, point, polygon, rectangular, etc. In an example, a region of interest may be used to create a binary mask image. In the mask image, the final image may be the same size as the original image but with pixels that belong to the region of interest set to 1 and pixels outside the region of interest set to 0. When a region of interest is detected, further processing may occur, by proceeding to operation 208 for determining whether a gesture is present or to operation 216 to determine whether a sign is present. These operations may be done sequentially or in parallel.

Operation 208 includes the start of gesture detection, and includes performing neighborhood and block processing. The image may be processed in sections to determine whether a gesture (e.g., a free flow gesture, meaning a hand or arm moving in free form, such as not conforming to a sign or input control gesture, such as a gesture specifically recognized to control an input of a system, for example to move a pointer or to select an input) has occurred. Neighborhood detection may be used, and the neighbors may be processed in blocks. A neighborhood detection technique may use a sliding neighborhood operation and extraction using image filtering in a spatial domain. For example, neighboring blocks or pixels from an image may be considered in a block.

In order to determine that a user movement is a gesture and not a sign, an image may be processed from left to right in a fixed size window (e.g., rectangular) of pixels. This moving window of pixels may be used to gather context and determine if and how a particular window corresponds to a previous or next window. For example, starting at a first window with a gesture portion, the gesture portion may be attached to a next window, which occurs just to the right of the first window. This process may continue until the end of the gesture is detected. This results in information about the free flow gesture at multiple levels that has been defined in following sections.

These neighbors are then processed as blocks of individual image areas. In an example, the neighbor blocks or pixels are grouped across more than one image (e.g., to detect a gesture, rather than a pose, which may be detected from a single image). The technique may include determining whether movement occurs from one image to another by comparing the blocks in the region of interest. After processing, the processed blocks, image, subimages, or images may be sent an ink group extraction algorithm for further processing at operation 210. This operation may be used to extract a gesture from identified movement from operation 208. The gesture may be extracted from the image, which may be in grayscale, may only include the region of interest, and may be a sparse image. Feature selection may be performed on the image using, for example, a curvelet transform technique. This transformation technique may include a multiscale transform technique. The curvelet transform works with images that have large amounts of curvatures and edges where edge information is captured by the transform to create an efficient feature set.

Operation 210 may include collecting Fourier samples of the image by using a Fourier Transform. and for each value obtained, multiply the angle window and the Fourier sample. This value may be superimposed at the origin of the image, and a 2D Fast Fourier Transform may be applied, resulting in a curvelet coefficient for the region of interest. The gesture identified by the curvelet coefficient may be stored as an image or represented mathematically.

The ink group extraction of operation 210 may include determining whether certain ink strokes are to be grouped together into a single inking stroke. This operation may include checking whether a stroke is performed or grouped in a similar manner to one or more strokes already in the ink group. A similarity score may be generated that is proportional to an average angle and distance between all the strokes in the ink group at the time they were added. The similarity score may be compared to angle and distance of the new stroke. Natural boundaries of strokes in a gesture may be derived from a distinction between handwriting and drawing a gesture, elapsed time since a previous stroke (e.g., where new content is typically created in bursts within a short time window), or distance from a previous stroke (e.g., where consecutive strokes separated by time and space are likely to be semantically unrelated). After boundaries are established, a determination may be made as to whether a first stroke in a subsequence part of an existing group should be or is part of a new ink group. Strokes that are not at the beginning of a sequence may be added to the same group as the first stroke of the subsequence. Ink proximity and ink density may be used to relate one stroke to another stroke in a semantic relationship. For example, ink changes inside or nearby an existing group may imply editing or extending the group. With the above information a particular user generating the gesture may be identified. An image representation of the gesture may be differentiated for the particular user, such as with a text annotation, a color, a location in the virtual whiteboard, etc. The above ink an stroke data along with gesture labeling may be used to train a model to determine inking strokes and handwriting for individual users, in an example. Features of the model may be based on characteristics such as length of ink strokes, curvature of paths, a maximum length of segments in a stroke, a minimum length of segments in a stroke, a time elapsed in making strokes, or the like.

After a gesture is extracted at operation 210, the gesture may be normalized to a coordinate system at operation 212. Normalization may include identifying a display coordinate system (e.g., for a virtual whiteboard). The gesture may be scaled to the display coordinate system and a location for placement of an image representation of the gesture on a display (e.g., a user interface such as displaying the virtual whiteboard) may be identified. The location for display of the image representation may be identified from a location of the region of interest within the image, may include moving the image representation when data is already displayed in the location or the virtual whiteboard, or may be selected to be in a blank space of the virtual whiteboard.

Normalizing the image may include converting the gesture to a particular coordinate system. For example, the determined ink strokes and ink groups may be translated into the coordinate system so that the gesture may be displayed on the virtual whiteboard. The ink group may be used to convert the gesture into an ink group coordinate system (e.g., which may be based on a coordinate system of the image). A display area (e.g., of a user interface for the virtual whiteboard) may be divided into a matrix data structure. The ink group (e.g., the gesture) may be superimposed onto the matrix. The coordinates of the ink groups may be mapped to the matrix. The mapped coordinates are used to draw the gesture on the user interface.

Ink translation in operation 214 may place the image representation on the virtual whiteboard by sending the image representation and information corresponding to a location to the user interface display operation 207. The user interface display may be updated at operation 207 to include the image representation of the gesture.

Operation 214 may include using the generated coordinates with an inking library to identify a start and an end of the gesture to be drawn. In an example there are other properties associated with the ink stroke that are taken into consideration. These properties may be passed along with the coordinates for display. The properties may include line thickness, color, pen type, etc.

The flowchart 200 includes operation 216 to start a sign recognition (and optionally language translation, such as from sign to text, text to speech, sign to speech, sign in one language to sign in another language, text to other language, etc.). Operation 216 includes normalizing the image (e.g., for color, size, etc.). After normalization, operation 218 includes feature extraction and selection. This operation may use a dataset including various signs (e.g., in a particular sign language or dialect of a sign language, such as American Sign Language, Indian Sign Language, British Sign Language, etc.). The dataset may include a large set of signs and their meaning (e.g., in a table). Using the dataset and the normalized image, a supervised learning algorithm may be run at operation 220 to determine a sign. In an example, a k-nearest neighbors algorithm may be used to determine the sign. This supervised learning algorithm divides the image into a certain class of object types already present in the dataset. Classification allows for the algorithm to define the type of the object in the image and to match the image with a set of images identifying the same sign. The supervised learning algorithm may be improved with feedback or additional images, as it may learn from new objects and their classes. After identification, the sign may be output (e.g., as data, such as text or an image representation).

Optional language translation at operation 222 may include using a translation service or component to translate the identified sign into another language, such as to text of a written language, to another sign language, or the like. Multiple translations may be generated (e.g., text and a sign in another language), a string of translations may occur (e.g., from the sign language to a written language to a second written language to a second sign language), or the like.

An image captured in operation 202 may include a depiction of one or more gestures, one or more signs, or both. For example, only a single gesture may be in an image or set of images. In another example, a sign (e.g., with one hand or by one person) and a gesture (e.g., by the other hand or by a second person) may be included. In yet another example, multiple signs may be present (e.g., from two or more users). In still other examples, multiple gestures and multiple signs may be present (e.g., with a plurality of users).

The output of the ink translation at operation 214 or the language translation at operation 222 (or the sign recognition at operation 220 if no translation occurs) may include information to be displayed on the user interface, such as using a virtual whiteboard. The user interface may use a facilitator component to receive the information and generate an output for a user. The facilitator may be a separate or integrated component with the sign language recognition and gesture recognition systems.

The facilitator manages representation of the information. In an example, the facilitator is an application including a virtual whiteboard, an online conference system, a collaboration document, a browser, or the like. When a sign was identified, the sign may be represented as an image or text and output using the user interface. An identified gesture may be represented as an image or vector and output using the user interface.

In some examples, outputs may include operations for free flow ink 224 (e.g., displaying a free form image representation 226 of the gesture), or a geometric shape (e.g., a normalized representation of the gesture, for example when the user gestures to draw a line, it may not be perfectly straight, but may be represented as a straight line), or the like. A sign may be represented as text in operation 226, which may be shown as words (e.g., in a text box or sticky note), or an image representation 226. The text may be output as speech in operation 228. In an example, a user may be mentioned or tagged 232 (e.g., identified in one or more signs or by a user after the text or image representation is displayed). When a determination is made in operation 232 that a user is mentioned or tagged, a notification may be output at operation 234. The notification may include displaying an @mention in the virtual whiteboard or elsewhere in the user interface, sending an email or text, generating a phone call to the user, speaking the user's name, or otherwise providing an alert.

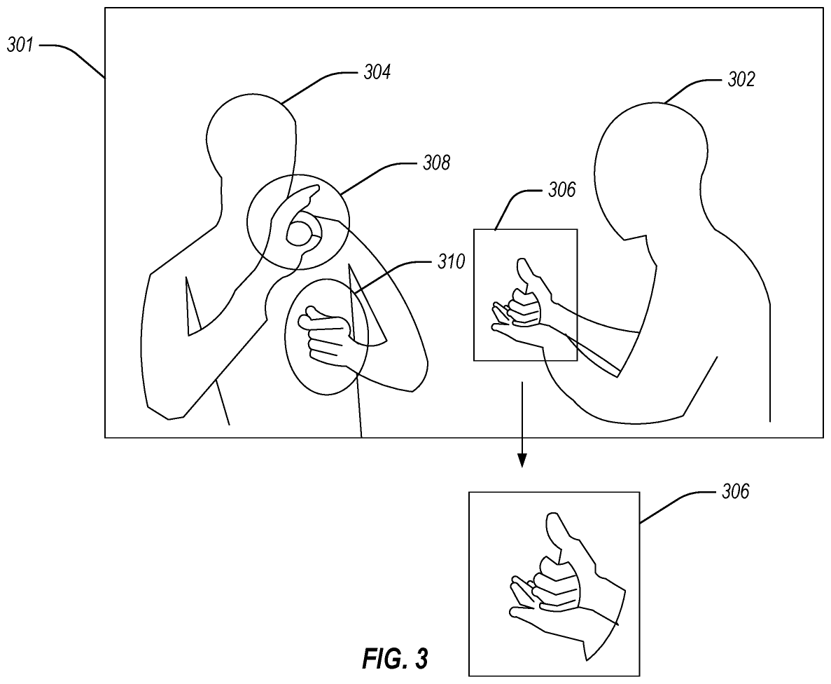

FIG. 3 illustrates an example image including a region of interest with a sign according to some examples of the present disclosure. The example image 301 is shown with multiple regions of interest 306, 308, 310 for illustration, but only a single region of interest may be present in an image. The regions of interest 306, 308, 310 in the image 301 include signs, but may include gestures in other examples. One region of interest 306, is shown in an enlarged view below the image 301 in FIG. 3 for illustrative purposes. The region of interest 306 is illustrated as a rectangle, but other geometric shapes, such as the circles or oval shown for regions 308 and 310 for user 304 may be used.

The region of interest 306 may be identified using the techniques described herein. For example, the image 301 may be mapped with a matrix data structure to break the image into different subimages or blocks. The image 301 may originally be in color, and may be converted to grayscale or may be originally in grayscale. In an example, noise may be removed from the grayscale image. A particular coordinate (e.g., a corner), such as a top-left coordinate, of the pixels including the hands of user 302 in the image 301 may be identified, and a bottom right coordinate including the hands may be identified (plus optionally an error margin). These two coordinates may be used to identify a top right and bottom left coordinate by swapping x and y coordinates of the already identified coordinates. The technique may include identifying a left most pixel, a top most pixel, a bottom most pixel, and a right most pixel of the hands, and using those to identify corner coordinates (plus optionally an error margin). In another example, a central point coordinate of the hands of the user 302 may be identified, as well as a point that is a maximum distance from the central point. Using a distance from the central to the maximum point (plus optionally an error margin) as a radius, a circle with the radius and the central point at the center may be generated as the region of interest. Other techniques for identifying the region of interest based on the classifier or machine learning model as described above (which may be used to recognize objects, such as hands in an image), may be used.

In an example, the regions of interest 308 and 310 may correspond to a single gesture or sign performed by the user 304. In this example, the regions 308 and 310 may be used together when generating a gesture or identifying a sign. For example, a dataset of signs may include an indication that the hands for a particular sign start apart and come together. When the hands are apart and are identified as two regions of interest, a sign language recognition system or model may compare the two regions to stored signs with the indication. Similarly, a single region of interest (e.g., region 306) may result in two regions of interest in a subsequent image as part of a sign where the hands start or come together and then move apart.

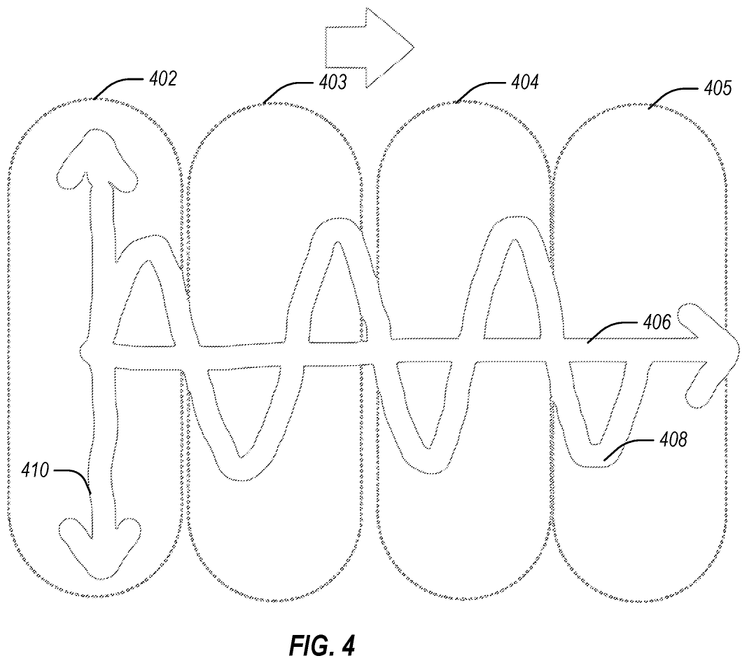

FIG. 4 illustrates an example captured gesture according to some examples of the present disclosure. The captured gesture may include multiple movements of a user, such as corresponding to the x-axis 406 and the sine wave 408. The movements may be made over different areas of a capture region (e.g., a field of view of a camera or a coordinate system of an image), such as starting in area 402, and proceeding (e.g., for the sine wave 408 and the x-axis 406) to area 403, area 404, and ending in area 405. The y-axis 410 may be entirely in area 402, where movement may be vertical. The captured gesture may be displayed as shown in FIG. 3 (optionally without the areas 402-405), or may be further processed, such as to smooth out edges, straighten lines, conform to curves, etc.

The three components 406, 408, and 410 of the captured gesture may be representations of separate movements. A technique may be performed to join the separate components together into the captured gesture. An image may be processed by generating a pixel window and moving the pixel window over different portions of the image. The window may be fixed in size and may connect pixels that are in order. The window may be used to determine a part of the image that remains connected (e.g., across the areas 402-405). The connected parts may be assembled as the captured gesture. Each component of the captured gesture may be an ink used for displaying the captured gesture (e.g., the components may be represented separately or as a single image representation). In an example, each component 406, 408, and 410 may be a separate vector, and the three components may be saved together as a single image file. In another example, the components may be combined to make a single vector.

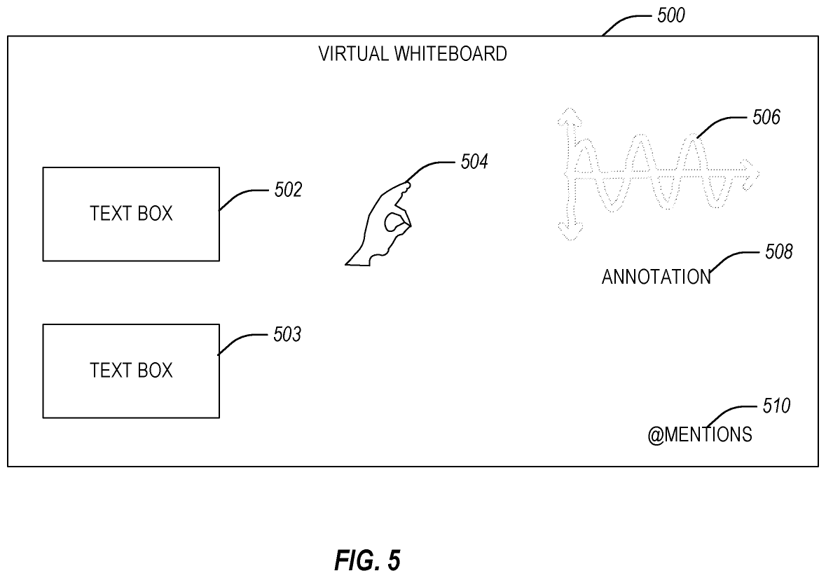

FIG. 5 illustrates an example virtual whiteboard user interface 500 on a display according to some examples of the present disclosure. The user interface 500 illustrates a virtual whiteboard including one or more components displayed in accordance with the systems and methods described herein. Although many components are displayed, one or more may be omitted, duplicated, moved, or changed in some examples.

The virtual whiteboard includes a first text box 502 and a second text box 503. The text boxes may be used to display user-entered text (e.g., by a keyboard, a virtual input, etc.) or generated from a sign captured as described above. In an example, a text box may include text generated from a sign that is editable by a user. The user interface 500 shows an image representation of a sign 504, an image representation of a gesture 506, an annotation 508 of the gesture, and an @mention 510 to indicate that a sign including a user's name or username was captured. The @mention 510 may be displayed along with the sign 504 or other information, such as when the @mention 510 corresponds to the sign 504. In another example, the @mention may be separate from other inputs. In some examples, the @mention 510 is only displayed on a user corresponding to the name. In an example, the annotation 508 may be user entered text or generated from a sign. The annotation 508 may be moved to a location near the image representation 506 of the gesture to annotate the information about the gesture. In an example, the annotation 508 may be generated from a gesture itself, such as an axis label (e.g., a gesture indicating “X”), a number, a letter, etc. The various components may be arranged in the virtual whiteboard automatically, such as according to location within a field of view of a camera that captured a sign or gesture corresponding to the component, location within a coordinate system of an image, predetermined location (e.g., text boxes in a left column, signs in a middle column, and gestures in a right column, with @mentions at the bottom), or the like. In an example, the components are moveable by a user, such as with a mouse, via a touchscreen, with a gesture, via a voice command, etc. The image representations of the sign 504 and the gesture 506 may be edited (e.g., they may be vector graphics, which may be modified). In an example, the sign 504 may be selectable when an incorrect image representation appears (e.g., the correct sign was not generated), and a new sign may be selected (e.g., when a sign language representation system has a second most likely sign to output, or from signs that are close to the sign 504, such as those with similar features).

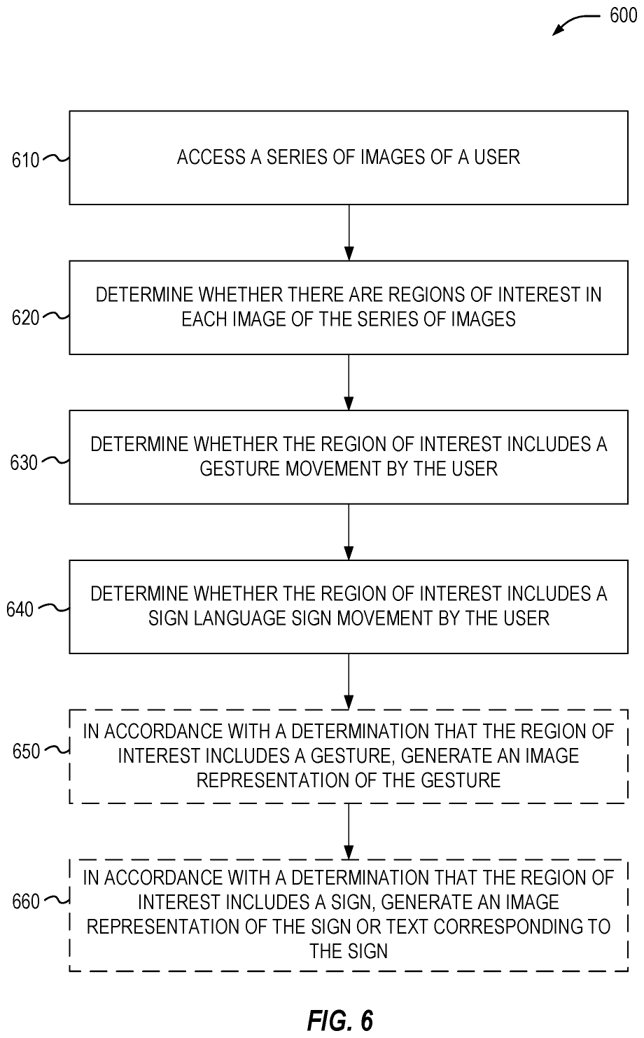

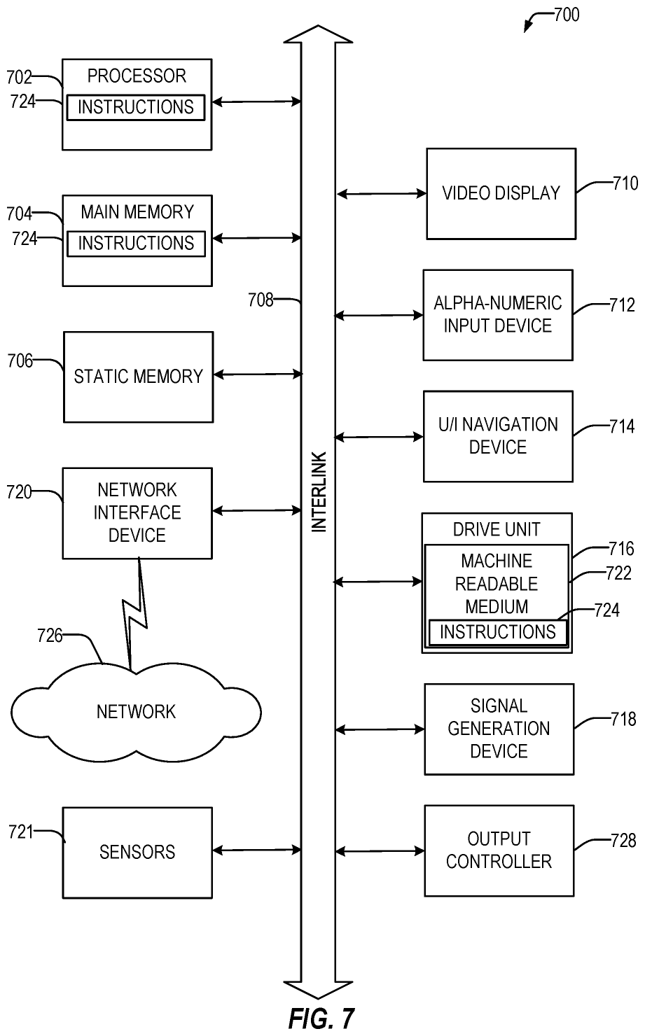

FIG. 6 illustrates a flowchart of a technique 600 for sign language and gesture identification and capture according to some examples of the present disclosure. The technique 600 may be performed using a processor or processors of a device, such as a computer, a laptop, a mobile device, or the like (e.g., as discussed in further detail below with respect to FIG. 1 or 7). For example, the technique 600 may be performed by a presentation system, such as a user device (e.g., a phone, a laptop, a desktop computer, etc.) or a server.

The technique 600 may be used to provide image representations of a sign that is performed by a user in a sign language or a gesture performed by the user. The gesture may be represented as a geometric shape, a plurality of geometric shapes, an image (e.g., a corresponding image, such as one preselected by the user or by a system), or the like. In some examples, instead of or in addition to the image representation of the sign, text corresponding to the sign may be generated. The text may be displayed or converted as audio and output via a speaker. The technique 600 may aid in communication or interpretation, such as for those with hearing or vision impairments, or for language translation (e.g., from a first sign language to a second sign language or to text in a language).

The technique 600 includes an operation 610 to capture a series of images of a user. After an image is captured, the technique 600 may include pre-processing each image of the series of images using at least one of blue and focus correction, filtering and noise removal, edge enhancements, or the like.

The technique 600 includes an operation 620 to determine whether there are regions of interest in each image of the series of images. In various examples, an image may have zero, one, or more than one region of interest. In an example, a region of interest includes a hand of a person. In response to determining that an image has a region of interest (e.g., a hand), further processing may occur. When no region of interest is identified for an image, that image may be disregarded without further processing or may be saved if needed for interpretation of a region of interest in an image adjacent or near in time (e.g., within a few frames, a few seconds, etc.).

The technique 600 includes an operation 630 to determine whether the region of interest includes a gesture movement by the user. Operation 630 may include processing an image or set of images of the series of images that include a region of interest, for example by processing a particular image and one or more additional images as a block. In an example, the particular image and the one or more additional images are neighbors in time in the series of images (e.g., occur sequentially or within a particular time range). Operation 630 may include using a sliding neighborhood operation on the particular image and the one or more additional images and extracting the gesture using image filtering in a spatial domain. In an example, operation 630 includes identifying a first movement and determining whether subsequent movements are related to the first movement based on similarity of angle and distance among the subsequent movements and the first movement.

The technique 600 includes an operation 640 to determine whether the region of interest includes a sign language sign movement by the user. Operations 630 and 640 may occur separately on the same region of interest, in some examples. These operations may be done in real-time or near real-time (e.g., within a second). In an example, operations 630 or 640 may include generating a binary mask image of the particular image, the binary mask image having pixels that belong to the region of interest set to one and pixels not belonging to the region of interest set to zero. In an example, operation 640 includes comparing the sign movement to stored signs in a dataset using a k-nearest neighbors supervised learning technique.

The technique 600 includes an optional operation 650 to in accordance with a determination that the region of interest includes a gesture, generate an image representation of the gesture. Operation 650 may include determining that the gesture movement indicates a gesture is included in the region of interest. The gesture may be determined based on a change within the region of interest or movement of the region of interest in two or more images (e.g., the image and one or more additional images of the series of images).

The technique 600 includes an optional operation 660 to in accordance with a determination that the region of interest includes a sign, generate an image representation of the sign or text corresponding to the sign. Operation 660 may include determining that the sign movement indicates a sign is included in the region of interest. The sign may be determined based on a change within the region of interest or movement of the region of interest in two or more images (e.g., the image and one or more additional images of the series of images). In an example, operation 660 includes outputting both the image representation of the sign and the text corresponding to the sign. The text may be output as visible words or emojis in a user interface, output as spoken words or sounds via a speaker, or the like. In an example, the sign that is identified in the region of interest may include a name of another user, such as another user in an online video conference. The other user may be notified (e.g., sent a notification in an application, sent an email, called, etc.) in response to determining the sign. Notifying the other user may include sending a text or sign (e.g., related to the determined sign, a previous sign, or a subsequent sign).

In an example, generating the image representation of the gesture or generating the image representation of the sign includes normalizing the image representation of the gesture or the image representation of the sign to a coordinate system of a user interface application. In this example, the normalized image representation of the gesture or the sign may be displayed using the user interface application. Both a sign and a gesture may be displayed simultaneously using the user interface application. In an example an image representation may be moved, changed, saved, etc. An image representation may include an scalable vector graphics (SVG) file format. FIG. 7 illustrates a block diagram of an example machine 700 which may implement one or more of the techniques (e.g., methodologies) discussed herein according to some examples of the 30) present disclosure. In alternative embodiments, the machine 700 may operate as a standalone device or may be connected (e.g., networked) to other machines. In a networked deployment, the machine 700 may operate in the capacity of a server machine, a client machine, or both in server-client network environments. The machine 700 may be configured to perform the methods of FIG. 5 or 6. In an example, the machine 700 may act as a peer machine in peer-to-peer (P2P) (or other distributed) network environment. The machine 700 may be a user device, a remote device.

a second remote device or other device which may take the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (hereinafter “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and

UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700) may include an output controller 728, such as a serial (e.g., universal serial bus (USB)), parallel, or other wired or wireless (e.g., infrared (IR), near field communication (NFC). High-Definition Multimedia Interface (HDMI), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices: magnetic disks, such as internal hard disks and removable disks: magneto-optical disks: Random Access Memory (RAM): Solid State Drives (SSD); and CD-ROM and

DVD-ROM disks. In some examples, machine readable media may be non-transitory machine-readable media. In some examples, machine readable media may include machine readable media that is not a transitory propagating signal.

The instructions 724 may further be transmitted or received over a communications network 726 using a transmission medium via the network interface device 720. The machine 700 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks). Plain Old Telephone (POTS) networks, and wireless data networks (e.g., Institute of Electrical and Electronics Engineers (IEEE) 802.11 family of standards known as Wi-FiR, IEEE 802.16 family of standards known as WiMax R:), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques.

Example 1 is a method for sign language and gesture identification and capture, the method comprising: accessing a series of images of a user: determining whether there are regions of interest in each image of the series of images: in response to determining that there is a region of interest in a particular image of the series of images, separately determining whether the region of interest includes a gesture movement by the user and determining whether the region of interest includes a sign language sign movement by the user: in accordance with a determination that the region of interest in the particular image includes a gesture, using the particular image and one or more additional images of the series of images to generate an image representation of the gesture; and in accordance with a determination that the region of interest in the particular image includes a sign, using the one or more additional images of the series of images to generate an image representation of the sign or text corresponding to the sign.

In Example 2, the subject matter of Example 1 includes, wherein the region of interest includes a hand or hands of the user or wherein the region of interest includes two regions of interest including a first region of interest including the gesture movement and a second region of interest 30) including the sign movement.

In Example 3, the subject matter of Examples 1-2 includes, wherein determining whether the region of interest includes the gesture movement includes processing the particular image and the one or more additional images as a block, the particular image and the one or more additional images being neighbors in time in the series of images.

In Example 4, the subject matter of Examples 1-3 includes, wherein determining whether the region of interest includes the gesture movement or the sign language sign movement includes generating a binary mask image of the particular image, the binary mask image having pixels that belong to the region of interest set to one and pixels not belonging to the region of interest set to zero. In Example 5, the subject matter of Examples 1˜4 includes, wherein determining whether the region of interest includes the gesture movement by the user includes using a sliding neighborhood operation on the particular image and the one or more additional images and extracting the gesture using image filtering in a spatial domain.

In Example 6, the subject matter of Examples 1-5 includes, before determining whether there are regions of interest in each image, pre-processing each image of the series of images using at least one of blue and focus correction, filtering and noise removal, or edge enhancements.

In Example 7, the subject matter of Examples 1-6 includes, wherein generating the image representation of the sign or text corresponding to the sign includes generating the text corresponding to the sign in real-time for display on a user interface.

In Example 8, the subject matter of Examples 1-7 includes, identifying that the sign includes a name of an other user in an online video conference, and sending a notification to the other user.

In Example 9, the subject matter of Examples 1-8 includes, wherein generating the image representation of the gesture or generating the image representation of the sign includes normalizing the image representation of the gesture or the image representation of the sign to a coordinate system of a user interface application, and further comprising displaying the normalized image representation of the gesture or the normalized image representation of the sign using the user interface application.

In Example 10, the subject matter of Examples 1-9 includes, wherein determining whether the region of interest includes the sign language sign movement by the user includes comparing the sign movement to stored signs in a dataset using a k-nearest neighbors supervised learning technique.

In Example 11, the subject matter of Examples 1-10 includes, wherein determining whether the region of interest includes the gesture movement by the user includes identifying a first movement and determining whether subsequent movements are related to the first movement based on similarity of angle and distance among the subsequent movements and the first movement.

Example 12 is at least one machine-readable medium including instructions for sign language and gesture identification and capture, which when executed by a processor, cause the processor to; access a series of images of a user: determine whether there are regions of interest in each image of the series of images: in response to determining that there is a region of interest in a particular image of the series of images, separately determine whether the region of interest includes a gesture movement by the user and determine whether the region of interest includes a sign language sign movement by the user: in accordance with a determination that the region of interest in the particular image includes a gesture, use the particular image and one or more additional images of the series of images to generate an image representation of the gesture; and in accordance with a determination that the region of interest in the particular image includes a sign, use the particular image and the one or more additional images of the series of images to generate an image representation of the sign or text corresponding to the sign.

In Example 13, the subject matter of Example 12 includes, wherein the region of interest includes a hand or hands of the user or wherein the region of interest includes two regions of interest including a first region of interest including the gesture movement and a second region of interest including the sign movement.

In Example 14, the subject matter of Examples 12-13 includes, wherein determining whether the region of interest includes the gesture movement includes processing the particular image and the one or more additional images as a block, the particular image and the one or more additional images being neighbors in time in the series of images.

In Example 15, the subject matter of Examples 12-14 includes, wherein determining whether the region of interest includes the gesture movement or the sign language sign movement includes generating a binary mask image of the particular image, the binary mask image having pixels that belong to the region of interest set to one and pixels not belonging to the region of interest set to zero.

In Example 16, the subject matter of Examples 12-15 includes, wherein determining whether the region of interest includes the gesture movement by the user includes using a sliding neighborhood operation on the particular image and the one or more additional images and extracting the gesture using image filtering in a spatial domain.

In Example 17, the subject matter of Examples 12-16 includes, before determining whether there are regions of interest in each image, pre-processing each image of the series of images using at least one of blue and focus correction, filtering and noise removal, or edge enhancements.

In Example 18, the subject matter of Examples 12-17 includes, wherein generating the image representation of the sign or text corresponding to the sign includes generating the text corresponding to the sign in real-time for display on a user interface.

Example 19 is an apparatus for sign language and gesture identification and capture, the apparatus comprising: means for accessing a series of images of a user: means for determining whether there are regions of interest in each image of the series of images: in response to determining that there is a region of interest in a particular image of the series of images, means for separately determining whether the region of interest includes a gesture movement by the user and determining whether the region of interest includes a sign language sign movement by the user; in accordance with a determination that the region of interest in the particular image includes a gesture, means for using the particular image and one or more additional images of the series of images to generate an image representation of the gesture; and in accordance with a determination that the region of interest in the particular image includes a sign, means for using the particular image and the one or more additional images of the series of images to generate an image representation of the sign or text corresponding to the sign.

In Example 20, the subject matter of Example 19 includes, wherein the means for generating the image representation of the gesture or the means for generating the image representation of the sign include means for normalizing the image representation of the gesture or the image representation of the sign to a coordinate system of a user interface application, and further comprising means for displaying the normalized image representation of the gesture or the normalized image representation of the sign using the user interface application.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

1. A method for sign language and gesture identification and capture, the method comprising:
accessing a series of images of a user;
determining, using a processor, whether there are regions of interest in each image of the series of images;
in response to determining that there is a region of interest in a particular image of the series of images, separately determining, using the processor, that (i) the region of interest includes a gesture movement by the user and (ii) the region of interest includes a sign language sign movement by the user;
in accordance with a determination that the region of interest in the particular image includes a gesture, using the particular image and one or more additional images of the series of images to generate an image representation of the gesture; and
in accordance with a determination that the region of interest in the particular image includes a sign, using the particular image and the one or more additional images of the series of images to generate an image representation of the sign or text corresponding to the sign.

2. The method of claim 1, wherein the region of interest includes a hand or hands of the user and wherein the region of interest includes two regions of interest including a first region of interest including the gesture movement and a second region of interest including the sign movement.

3. The method of claim 1, wherein determining that the region of interest includes the gesture movement includes processing the particular image and the one or more additional images as a block, the particular image and the one or more additional images being neighbors in time in the series of images.

4. The method of claim 1, wherein determining that the region of interest includes the gesture movement or the sign language sign movement includes generating a binary mask image of the particular image, the binary mask image having pixels that belong to the region of interest set to one and pixels not belonging to the region of interest set to zero.

5. The method of claim 1, wherein determining that the region of interest includes the gesture movement by the user includes using a sliding neighborhood operation on the particular image and the one or more additional images and extracting the gesture using image filtering in a spatial domain.

6. The method of claim 1, further comprising, before determining whether there are regions of interest in each image, pre-processing each image of the series of images using at least one of blue and focus correction, filtering and noise removal, or edge enhancement.

7. The method of claim 1, wherein generating the image representation of the sign or text corresponding to the sign includes generating the text corresponding to the sign in real-time for display on a user interface.

8. The method of claim 1, further comprising identifying that the sign includes a name of an other user in an online video conference, and sending a notification to the other user.

9. The method of claim 1, wherein generating the image representation of the gesture or generating the image representation of the sign includes normalizing the image representation of the gesture or the image representation of the sign to a coordinate system of a user interface application, and further comprising displaying the normalized image representation of the gesture or the normalized image representation of the sign using the user interface application.

10. The method of claim 1, wherein determining that the region of interest includes the sign language sign movement by the user includes comparing the sign movement to stored signs in a dataset using a k-nearest neighbors supervised learning technique.

11. The method of claim 1, wherein determining that the region of interest includes the gesture movement by the user includes identifying a first movement and determining whether one or more subsequent movements are related to the first movement based on similarity of angle and distance among the one or more subsequent movements and the first movement.

12. At least one non-transitory machine-readable medium including instructions for sign language and gesture identification and capture, which when executed by a processor, cause the processor to:
access a series of images of a user;
determine whether there are regions of interest in each image of the series of images;
in response to determining that there is a region of interest in a particular image of the series of images, separately determine that (i) the region of interest includes a gesture movement by the user and (ii) the region of interest includes a sign language sign movement by the user;
in accordance with a determination that the region of interest in the particular image includes a gesture, use the particular image and one or more additional images of the series of images to generate an image representation of the gesture; and
in accordance with a determination that the region of interest in the particular image includes a sign, use the particular image and the one or more additional images of the series of images to generate an image representation of the sign or text corresponding to the sign.

13. The at least one non-transitory machine-readable medium of claim 12, wherein the region of interest includes a hand or hands of the user and wherein the region of interest includes two regions of interest including a first region of interest including the gesture movement and a second region of interest including the sign movement.

14. The at least one non-transitory machine-readable medium of claim 12, wherein determining that the region of interest includes the gesture movement includes processing the particular image and the one or more additional images as a block, the particular image and the one or more additional images being neighbors in time in the series of images.

15. The at least one non-transitory machine-readable medium of claim 12, wherein determining that the region of interest includes the gesture movement or the sign language sign movement includes generating a binary mask image of the particular image, the binary mask image having pixels that belong to the region of interest set to one and pixels not belonging to the region of interest set to zero.
